(19) United States
(12) Patent Application Publication
(10) Pub. No.: US 2013/0076176 A1
(43) Pub. Date: Mar. 28, 2013

(54) STATOR TERMINAL BLOCK FOR A MULTI-PHASE ELECTRIC MACHINE

(71) Applicants: Samuel Edrington, Noblesville, IN (US); Chad Zook, Anderson, IN (US)

(72) Inventors: Samuel Edrington, Noblesville, IN (US); Chad Zook, Anderson, IN (US)

(73) Assignee: REMY TECHNOLOGIES, L.L.C., Pendleton, IN (US)

(21) Appl. No.: 13/240,557

(22) Filed: Sep. 22, 2011

(51) Int. Cl. H02K 11/00

(52) U.S. Cl. 310/71

(57) ABSTRACT

A stator terminal block including a body member, a plurality of terminal elements provided on the body member, a plurality of stator winding receiving elements provided on the body member and one or more connector members are provided at the body member. The one or more connector members electrically interconnect select ones of the plurality of stator winding receiving elements. A plurality of connector elements is provided at the body member. The plurality of connector elements electrically interconnect select ones of the one or more connector members with select ones of the plurality of terminal elements.

### BACKGROUND OF THE INVENTION

Exemplary embodiments pertain to the art of electric machines and, more particularly, to a stator terminal block for a multi-phase electric machine.

Multi-phase electric machines include a stator that is provided with multiple stator windings. Each stator winding has free ends that are connected to an external component such as a power source (in the case of an electric motor) or a load (in the case of an electric generator), or to another of the stator windings. More specifically, the stator windings are generally connected in such a way so as to establish various stator configurations such as wye and delta, which provide unique operating characteristics for the electric machine. Generally, after forming the stator, internal or winding to winding connections are joined by solder joints while external connections are joined to a terminal block. The terminal block includes a number of terminals that are configured to connect with the external component.

### BRIEF DESCRIPTION OF THE INVENTION

Disclosed is a stator terminal block including a body member, a plurality of terminal elements provided on the body member, a plurality of stator winding receiving elements provided on the body member and one or more connector members are provided at the body member. The one or more connector members electrically interconnect select ones of the plurality of stator winding receiving elements. A plurality of connector elements is provided at the body member. The plurality of connector elements electrically interconnect select ones of the one or more connector members with select ones of the plurality of terminal elements.

Also disclosed is an electric machine including a stator including a plurality of windings. Each of the plurality of windings includes first and second end portions. A rotor is arranged within the stator, and a stator terminal block is operatively connected to the stator. The stator terminal block includes a body member, a plurality of terminal elements is provided on the body member and a plurality of stator winding receiving elements is provided on the body member. The plurality of stator winding receiving elements receive corresponding ones of the first and second end portions of the plurality of stator windings. One or more connector members are provided at the body member. The one or more connector members electrically interconnect select ones of the plurality of stator winding receiving elements to establish a desired configuration for the plurality of stator windings. A plurality of connector elements is provided at the body member. The plurality of connector elements electrically interconnect select ones of the one or more connector members with select ones of the plurality of terminal elements.

Further disclosed a stator for an electric machine includes a stator core, a plurality of stator windings extending about the stator core, and a stator terminal block electrically connected to the stator windings. The stator terminal block includes a body member, a plurality of terminal elements provided on the body member, and a plurality of stator winding receiving elements provided on the body member. The plurality of stator winding receiving elements receive end portions of each of the plurality of stator windings. One or more connector members are provided at the body member. The one or more connector members electrically interconnect select ones of the plurality of stator winding receiving elements to establish a desired configuration for the plurality of stator windings. A plurality of connector elements is provided at the body member. The plurality of connector elements electrically interconnect select ones of the one or more connector members with select ones of the plurality of terminal elements.

### BRIEF DESCRIPTION OF THE DRAWINGS

The following descriptions should not be considered limiting in any way. With reference to the accompanying drawings, like elements are numbered alike:

FIG. 1 depicts a perspective view of a portion of an electric machine including a stator terminal block in accordance with an exemplary embodiment;

FIG. 2 depicts a cross-sectional view of the electric machine of FIG. 1;

FIG. 3 depicts a perspective view of the stator terminal block in accordance with an exemplary embodiment; and

FIG. 4 depicts a cut-away view of the stator terminal block of FIG. 3.

### DETAILED DESCRIPTION OF THE INVENTION

A detailed description of one or more embodiments of the disclosed apparatus and method is presented herein by way of exemplification and not limitation with reference to the Figures.

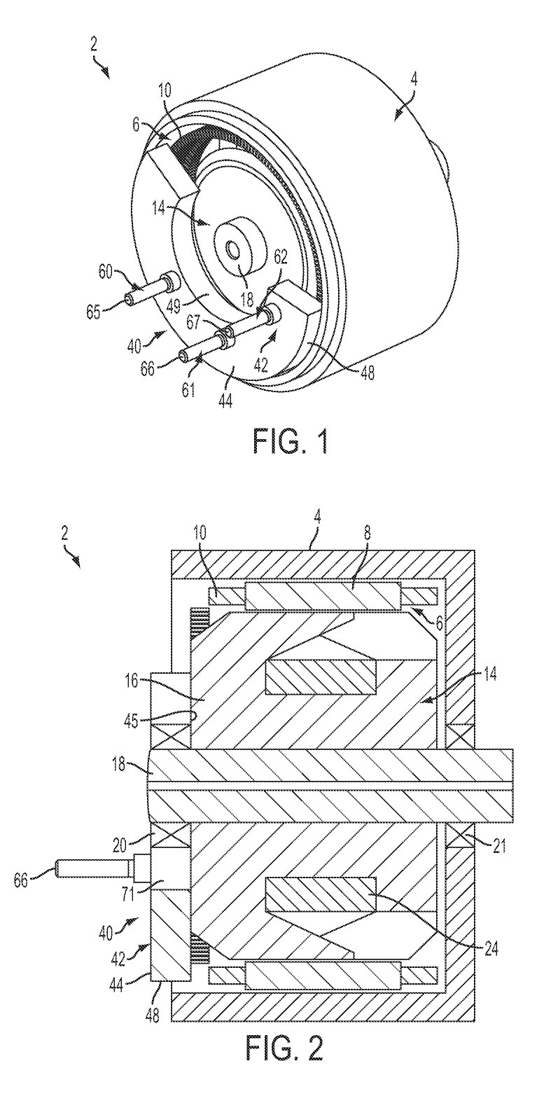

With reference to FIGS. 1-2, a portion of an electric machine in accordance with an exemplary embodiment is indicated generally at 2. Electric machine 2 includes a housing 4 that surrounds a stator 6. Stator 6 includes a stator core 8 wound with a plurality of stator windings 10. The number of stator windings can vary depending upon desired characteristics of electric machine 2. Electric machine 2 is also shown to include a rotor assembly 14 rotatably mounted within stator core 8. Rotor assembly 14 includes a rotor core 16 that is mounted to a shaft 18. Shaft 18 is supported to housing 4 through a pair of bearings 20 and 21. Rotor assembly 14 is also shown to include rotor windings 24 that extend about rotor core 16.

With this arrangement, when functioning as an electric motor, application of an electric current to stator windings 10 generates an electromotive force that induces rotation of rotor assembly 14. Conversely, when functioning as an electrical generator, rotation of rotor assembly 14 generates an electromotive force that leads to development of an electrical current in stator windings 10. Accordingly, stator windings 10 are coupled to an external component (not shown). When acting as an electric machine, the external component may be a source of electrical current. When acting as a generator, the electrical component may be an electrical load.

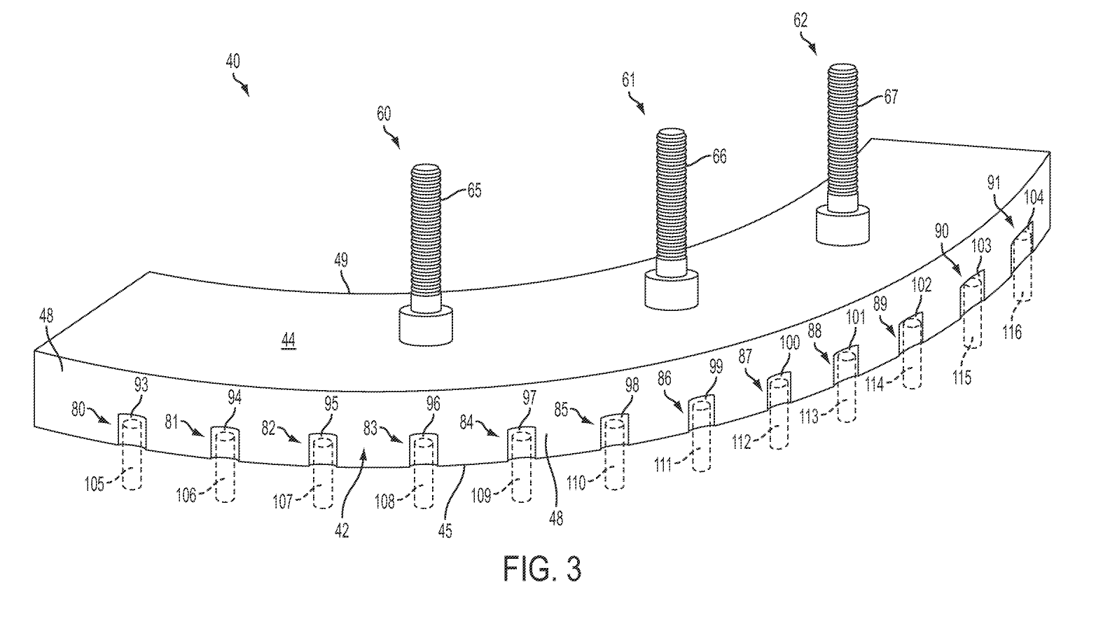

In accordance with an exemplary embodiment, electric machine 2 includes a stator terminal block 40 that leads electrical current to and/or from stator windings 10. As shown in FIG. 3, stator terminal block 40 includes a body member 42 having a first or outer surface 44 and a second or inner surface 45. First and second surfaces are joined by a first or outer edge portion 48 and a second or inner edge portion 49. First edge portion 48 is shown to include a convex curvilinear surface that substantially corresponds to an outer surface profile (not separately labeled) of housing 4. Conversely, second edge portion 49 includes a concave curvilinear surface that roughly corresponds to an inner surface geometry (not separately labeled) of housing 4.

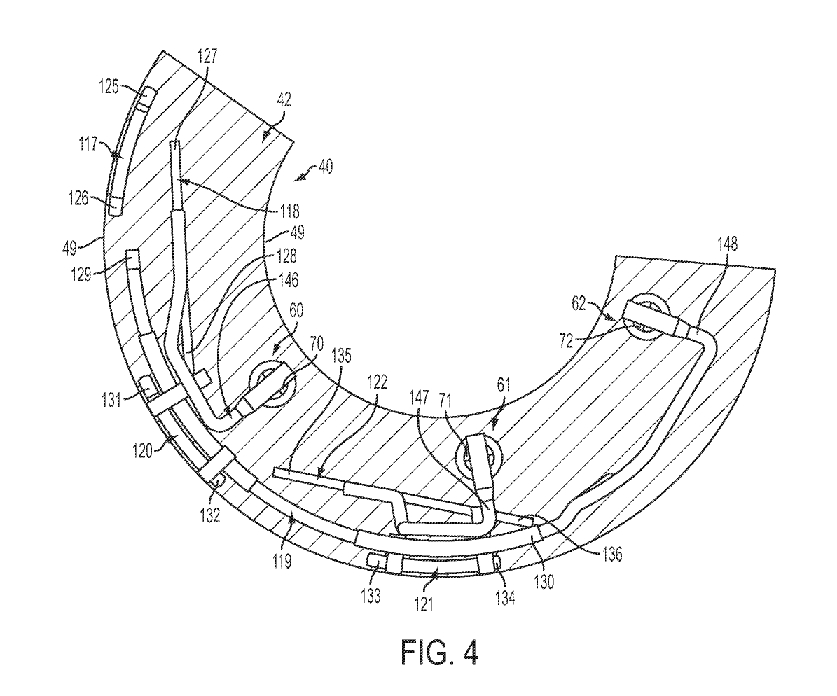

In further accordance with the exemplary embodiment, stator terminal block 40 includes a plurality of terminal members 60-62 that extend from first surface 44. Each terminal member 60-62 includes a respective first end 65-67 that is configured to receive conductors that electrically connect stator windings 10 with the external component. Terminal members 60-62 also include respective second ends 70-72 (FIG. 4) that, as will become more fully evident below, are electrically coupled to stator windings 10. Stator terminal block 40 is also shown to include a plurality of stator winding receiving elements 80-91. Stator winding receiving elements 80-91 are shown as recesses 93-104 arrayed along first edge portion 48. Of course it should be understood that the particular location of receiving elements 80-91 could vary. In the exemplary embodiment shown, recesses 93-104 have a generally circular cross-section. However, it should be understood that the size, shape, and number of recesses 93-104 could vary. More specifically, stator windings 10 include a number of end portions 105-116 that are received in stator receiving elements 80-91. The size/shape of recesses 93-104 coincide to a geometry, e.g., circular or rectangular, of conductors used to form stator windings 10.

Stator terminal block 40 also includes a plurality of connector members 117-122 that are arranged within body member 42. Connector members 117-122 are electrically connected with stator winding receiving elements 80-91. More specifically, connector members 117-122 include corresponding end or connecting portions 125-136 that are electrically connected to end portions 105-116 of stator windings 10 at stator winding receiving elements 80-91. Stator terminal block 40 is also shown to include a plurality of connector elements 146-148 that connect respective ones of terminal members 60-62 to desired ones of connector members 117-122. In this manner, stator terminal block 40 not only provides structure for connecting to external components, but also creates desired connections between the stator windings to facilitate a desired wiring configuration. For example, stator terminal block can be formed such that the connector members and connector elements establish a wye connection, a delta connection, or other form of electrical connection for the electric machine. The stator terminal block in accordance with the exemplary embodiments could be provided in a wide array of electric machine types including brushed and brushless machines.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A stator terminal block comprising:
a body member;
a plurality of terminal elements provided on the body member;
a plurality of stator winding receiving elements provided on the body member;
one or more connector members provided at the body member, the one or more connector members electrically interconnecting select ones of the plurality of stator winding receiving elements; and
a plurality of connector elements provided at the body member, the plurality of connector elements electrically interconnecting select ones of the one or more connector members with select ones of the plurality of terminal elements.

2. The stator terminal block according to claim 1, wherein the body member includes a first edge portion and a second edge portion, the plurality of stator winding receiving elements being arranged along the first edge portion.

3. The stator terminal block according to claim 1, wherein the one or more connector members are arranged within the body member.

4. The stator terminal block according to claim 1, wherein the one or more connector members are configured and disposed to establish one of a wye and a delta connection configuration.

5. The stator terminal block according to claim 1, wherein a plurality of stator winding receiving elements are formed in the body member.

6. An electric machine comprising:
a stator including a plurality of windings, each of the plurality of windings including end portions;
a rotor arranged within the stator; and
a stator terminal block operatively connected to the plurality of stator windings, the stator terminal block comprising:
a body member;
a plurality of terminal elements provided on the body member;
a plurality of stator winding receiving elements provided on the body member, the plurality of stator winding receiving elements receiving corresponding ones of the first and second end portions of the plurality of stator windings;
one or more connector members provided at the body member, the one or more connector members electrically interconnecting select ones of the plurality of stator winding receiving elements to establish a desired configuration for the plurality of stator windings; and
a plurality of connector elements provided at the body member, the plurality of connector elements electrically interconnecting select ones of the one or more connector members with select ones of the plurality of terminal elements.

7. The electric machine according to claim 6, wherein the body member includes a first edge portion and a second edge portion, the plurality of stator winding receiving elements being arranged along the first edge portion.

8. The electric machine according to claim 6, wherein the one or more connector members are arranged within the body member.

9. The electric machine according to claim 6, wherein the one or more connector members are configured and disposed to establish one of a wye and a delta connection configuration.

10. The electric machine according to claim 6, wherein a plurality of stator winding receiving elements are formed in the body member.

11. A stator for an electric machine comprising:
a stator core;
a plurality of stator windings extending about the stator core; and
a stator terminal block electrically connected to the plurality of stator windings, the stator terminal block comprising:
a body member;
a plurality of terminal elements provided on the body member;
a plurality of stator winding receiving elements provided on the body member, the plurality of stator winding receiving elements receiving end portions of each of the plurality of stator windings;
one or more connector members provided at the body member, the one or more connector members electrically interconnecting select ones of the plurality of stator winding receiving elements to establish a desired configuration for the plurality of stator windings; and
a plurality of connector elements provided at the body member, the plurality of connector elements electrically interconnecting select ones of the one or more connector members with select ones of the plurality of terminal elements.

12. The stator according to claim 11, wherein the body member includes a first edge portion and a second edge portion, the plurality of stator winding receiving elements being arranged along the first edge portion.

13. The stator according to claim 11, wherein the one or more connector members are arranged within the body member.

14. The stator according to claim 11, wherein the one or more connector members are configured and disposed to establish one of a wye and a delta connection configuration.

15. The stator according to claim 11, wherein a plurality of stator winding receiving elements are formed in the body member.
